(19) United States
(12) Patent Application Publication
(10) Pub. No.: US 2026/0029320 A1
(43) Pub. Date: Jan. 29, 2026

(54) COMBINED MICROFLUIDIC RESISTIVE PULSE SENSING AND FLUORESCENCE DEVICE

(71) Applicant: SPECTRADYNE LLC, Signal Hill, CA (US)

(72) Inventors: Jean-Luc FRAIKIN, Signal Hill, CA (US); Peter MEINHOLD, Signal Hill, CA (US); Andrew CLELAND, Signal Hill, CA (US)

(21) Appl. No.: 18/996,588

(22) PCT Filed: Aug. 17, 2023
(86) PCT No.: PCT/US2023/072429

§ 371 Date: Jan. 17, 2025

Related U.S. Application Data
(60) Provisional application No. 63/371,734, filed on Aug. 17, 2022.

(51) Int. Cl. G01N 15/0205; B01L 3/00; G01N 15/02; G01N 15/12; G01N 15/1434

(52) U.S. Cl. CPC G01N 15/0205; B01L 3/502707; B01L 3/502715; G01N 15/0266; G01N 15/12; B01L 2200/025; B01L 2200/027; B01L 2300/0654; B01L 2300/0663; G01N 2015/1452

(57) ABSTRACT

The devices and methods disclosed herein relate to combined microfluidic resistive pulse sensing and fluorescence to accurately and quantitatively measuring the size, concentration and single-particle fluorescence of nanoparticles in complex, heterogenous samples. The devices include an optics module, a cartridge interface, and a fluids module.

### TECHNICAL FIELD OF THE INVENTION

The devices and methods disclosed herein relate to combined microfluidic resistive pulse sensing and fluorescence to accurately and quantitatively measuring the size, concentration and single-particle fluorescence of nanoparticles in complex, heterogenous samples.

### BACKGROUND TO THE INVENTION

Applications for nanoparticles are increasing rapidly. Basic physical properties, such as size and concentration, dictate the performance of these materials. Existing technologies use indirect methods to measure size and concentration and yield misleading results, particularly when the particles are polydispersed in size or heterogeneous in material properties. A critical need therefore exists for technology that can accurately measure the concentration and size of specific particles. Because many common nanoparticles are produced in biological systems that generate other particles, e.g., cell culture, a key requirement for any solution to this need is that it be able to quantify specific subpopulations of particles in a mixture of other particles.

Using biochemical or other techniques to fluorescently label one or more specific particle subpopulations in a heterogeneous sample is a well-known and successful approach in other applications, e.g., microscopy and flow cytometry for larger particles and cells (Review of Scientific Instruments 55, 1375 (1984); https://doi.org/10.1063/1.1137948), the disclosure of which is hereby incorporated by reference in its entirety. Labeling may be performed by binding fluorescent antibodies, chemically coupling fluorochromes or by engineering a biological system to express fluorescent structures on the particles as they are produced. Many well-established protocols exist for doing so that have been validated and characterized in the field. A good solution for quantifying particle subpopulations would benefit from being compatible with these well-established methods.

### SUMMARY OF THE INVENTION

The invention described herein relates to devices for combined fluorescence and microfluidic resistive pulse sensing. In some embodiments, the device disclosed herein includes an optics module, a stage for holding a microfluidic analysis cartridge, a cartridge interface, and a fluids module.

In some embodiments, the optics module includes one or more optical components mounted to a multi-axis positioning system. In some embodiments, the multi-axis positioning system is capable of positioning the one or more optical components relative to the stage. In some embodiments, the stage provides a means for positioning a cartridge relative to the cartridge interface.

In some embodiments, the fluids module is fluidically connected to the cartridge interface. In some embodiments, the fluids module includes components for controlling pressures and directing fluids in a microfluidic analysis cartridge.

In some embodiments, the optics module includes a source of excitation light, an epifluorescence module, and a detection module. In some embodiments, the source of excitation light includes a diode laser, a mercury lamp, or a filtered broad-band illumination source. In some embodiments, the device further includes one or more components for conditioning the excitation light. In some embodiments, the one or more components for conditioning the source of excitation light include beam shaping optics selected from a vortex plate, a top-hat beam shaper, a diffuser, an objective lens, and a pitch-yaw adjuster. In some embodiments, the epifluorescence module includes an objective lens, a dichroic mirror, a fiber collimator, or a splitter mirror. In some embodiments, the wavelength separation module includes a fiber collimator. In some embodiments, the wavelength separation module includes one or more dichroic mirrors and one or more optical filters.

In some embodiments, the optics module further includes an imaging module. In some embodiments, the imaging module includes one or more focusing optics or a digital camera. In some embodiments, the optics module further includes a fiber splitter. In some embodiments, the fiber splitter joins two or more fiberoptic terminals. In some embodiments, the optics module further includes a source of alignment light. In some embodiments, the optics module further includes a wavelength separation module.

In some embodiments, the stage for holding a microfluidic cartridge includes an optically transparent region. In some embodiments, the optically transparent region includes a glass wafer. In some embodiments, the cartridge interface includes one or more electrical interfacing components. In some embodiments, the cartridge interface includes one or more fluid interfacing components.

In some embodiments, a microfluidic cartridge is provided. In some embodiments, the microfluidic cartridge includes one or more electrical contacts for sensing and one or more reference markings for focusing and aligning the one or more optical components in the optics module of the device described herein. In some embodiments, the one or more reference markings are built into one or more fluidic channels and include patterns that are recognizable by automated image analysis algorithms. In some embodiments, the patterns are in the shape of two or more intersecting lines. In some embodiments, the one or more reference markings are separate from any fluid channels in the cartridge. In some embodiments, the one or more reference markings are one or more conductive electrical contacts.

Methods of using the device described herein are also disclosed.

### BRIEF DESCRIPTION OF THE DRAWINGS

FIG. 1 is an illustration an exemplary combined microfluidic resistive pulse sensing and fluorescence device according to embodiments of the invention disclosed herein.

FIG. 2 is an illustration of an exemplary optics module of the device disclosed herein.

FIG. 3 is an illustration of an exemplary epifluorescence module of the device disclosed herein.

FIG. 4 is an illustration of an exemplary epifluorescence module of the device disclosed herein.

FIG. 5 is an illustration of an exemplary fiber splitter according to the invention disclosed herein.

FIG. 6 is an illustration of an exemplary detection module of the device disclosed herein.

FIG. 7 is an illustration of an exemplary wavelength separation module of the device disclosed herein.

FIG. 8 is an expanded view of an exemplary enclosure for the device disclosed herein.

FIG. 9 is an illustration of an exemplary enclosure for the device disclosed herein illustrating a removable panel for accessing components of the wavelength separation module.

FIG. 10 is an illustration showing the interior of an exemplary combined microfluidic resistive pulse sensing and fluorescence device according to embodiments of the invention disclosed herein.

FIG. 11 is an illustration of an exemplary microfluidic cartridge according to the invention disclosed herein.

FIG. 12 is an illustration of the combined microfluidic resistive pulse sensing and fluorescence device according to embodiments of the invention disclosed herein showing the stage for holding a microfluidic analysis cartridge.

FIG. 13 is an illustration of an exemplary stage for holding a microfluidic analysis cartridge according to embodiments of the invention disclosed herein.

FIG. 14 is an illustration of an exemplary stage for holding a microfluidic analysis cartridge according to embodiments of the invention disclosed herein.

FIG. 15 an illustration of an exemplary stage for holding a microfluidic analysis cartridge according to embodiments of the invention disclosed herein showing a detector mounted thereon.

FIG. 16 is an illustration of an exemplary positioning stage according to embodiments of the invention disclosed herein.

FIG. 17 is an illustration of an exemplary cartridge interface and stage for holding a microfluidic cartridge according to embodiments of the invention disclosed herein.

FIG. 18 is an illustration of an exemplary cartridge interface and stage for holding a microfluidic cartridge according to embodiments of the invention disclosed herein.

FIG. 19 is an illustration of an exemplary cartridge interface and stage for holding a microfluidic cartridge according to embodiments of the invention disclosed herein.

FIG. 20 is an illustration of an exemplary cartridge interface and stage for holding a microfluidic cartridge according to embodiments of the invention disclosed herein

FIG. 21 is an illustration of an exemplary cartridge interface and stage for holding a microfluidic cartridge according to embodiments of the invention disclosed herein.

FIG. 22 an illustration of an exemplary cartridge interface and stage for holding a microfluidic cartridge according to embodiments of the invention disclosed herein.

FIG. 23 is an illustration of an exemplary fluidics module of the device disclosed herein.

FIG. 24 is an illustration of an exemplary fluidics module of the device disclosed herein.

### DETAILS OF INVENTION

The combination devices and methods disclosed herein relate to combined microfluidic resistive pulse sensing and fluorescence to accurately and quantitatively measuring the size, concentration and single-particle fluorescence of nanoparticles in complex, heterogenous samples. The devices disclosed herein include an optics module, a cartridge interface, and a fluids module.

Using the fluorescent labeling method of particle identification is an even more powerful tool when measurement of the emitted fluorescence can be made quantitative and traceable to units of absolute brightness. The brightness of fluorescence can then be used to quantify the number of fluorochromes on the particle, which in turn can provide quantitative measurements of molecular structure of the particles, for example, the number of binding sites on the surface of the particle to which a fluorescent antibody has bound. Molecular structure on the surface of particles is an important physical parameter that determines a particle's function, e.g., the affinity of a therapeutic particle to bind to a specific type of tumor cell in a cancer treatment. In addition to identifying specific particles of interest in a heterogenous mixture, the desired solution should also be able to quantify the brightness of any fluorescence emitted from the particles.

Another desirable feature of a fluorescence-based method for nanoparticle identification is a high sensitivity to fluorescence light, or in other words, a low limit of detection for fluorescence. As particles get smaller, the number of fluorochromes, and therefore the total brightness of each particle is practically limited by how many fluorochromes can be attached to the particle or embedded within it. For relevant biological nanoparticles, the number of accessible antibody binding sites to which fluorochromes can be bound may be as low as one per particle, requiring sensitivity to an extremely low level of fluorescent light.

Fluorescence nanoparticle tracking analysis (f-NTA) is described in JExtracellVesicles. 2021; 10:e12079, (https://doi.org/10.1002/jev2.12079), the disclosure of which is hereby incorporated by reference in its entirety. Nanoparticle tracking analysis is a method for counting and sizing particles in which the light scattered or emitted by nanoparticles over time is measured to infer the size of particles from the dynamics of their Brownian motion (Journal of Thrombosis and Haemostasis 12(7), 1182-(2014)), the disclosure of which is hereby incorporated by reference in its entirety. This method lacks sensitivity for detecting small particles when they are present in a mixture with larger particles however (JExtracellVesicles.2021; 10:e12079, https://doi.org/10.1002/jev2.12079), the disclosure of which is hereby incorporated by reference in its entirety and suffers from a variable size limit of detection that depends on the composition of the sample itself. The fluorescence-NTA method further requires that fluorescent particles be illuminated at their excitation wavelengths for times that are long enough to capture the diffusion dynamics. The long excitation times required by this method cause photobleaching of most fluorophores, leading to a variable brightness over time during a measurement. In practice therefore, the f-NTA method does not provide accurate size, concentration or quantitative fluorescence detection of particles.

Flow cytometry (FC) is a method for counting and sizing particles in which light that is scattered or emitted by particles is measured to infer their size as they flow through a flow cell. FC is a powerful and well-established technique for quantifying subpopulations of larger particles and cells. FC is fundamentally limited to larger particles because the intensity of scattered light diminishes strongly with the diameter of the particle (6^{th} power dependence in relevant size range), making small particles exceedingly difficult to detect. Also, the inference of particle size from scattered light intensity depends critically on a number of assumptions including the optical properties of the particle such as the index of refraction and the optical structure of the particle ((Sci Rep 11, 24151 (2021) https://doi.org/10.1038/s41598-021-03015-2), the disclosure of which is hereby incorporated by reference in its entirety. This dependence makes analyzing heterogenous samples impractical, since the optical properties of any single particle are not known in advance. The challenges of using flow cytometry to accurately measure particle size at the nanoscale regime are clear in the literature, as evidenced by contentious exchanges of opinion in the literature ((Sci Rep 9, 16039 (2019) https://doi.org/10.1038/s41598-019-52366-4, (Sci Rep 11, 24151 (2021) https://doi.org/10.1038/s41598-021-03015-2, Sci Rep 11, 24170 (2021) https://doi.org/10.1038/s41598-021-03113-1), the disclosure of each of which is hereby incorporated by reference in its entirety.

Microfluidic Resistive Pulse Sensing (MRPS) is a non-optical method for counting and sizing nanoparticles in which an electrical signal is measured as each particle passes through a microfluidic constriction under applied electrical bias ((Nature Nanotech 6, 308-313 (2011) https://doi.org/10.1038/nnano.2011.24, U.S. Pat. Nos. 8,901,914, 9,945,802), the disclosure of each of which are hereby incorporated by reference in its entirety. The amplitude and time-dependent profile of the electrical signal generated by each particle are used with very few assumptions to calculate the particle's volume and the rate of fluid flow through the sensing constriction respectively. The rate of fluid flow is in turn used to measure the total volume of sample in which particles are detected, which allows determination of the absolute concentration of particles over the measurement size range. MRPS is therefore a very direct method for measuring the size and concentration of particles in a liquid. The microfluidic implementation of the MRPS method also affords other engineered fluidic features (e.g., embedded filters) that enable accurate measurements of particle size and concentration at fast rates and in complex, heterogenous samples.

A key strength of the MRPS method is that its sensitivity does not depend sensitively on the material composition of the particles being detected. However, MRPS cannot also easily be used to identify specific particle subpopulations in a heterogenous sample, unless size is a dominant identifying feature of the subpopulation (i.e., a prominent peak in the particle size distribution). This method therefore has limited utility in applications in which the particles of interest are present at lower concentration than other particles having similar size in the sample to be analyzed.

While both Flow Cytometry and MRPS can be used separately to analyze a single sample, the results of this combination of measurements are analytically insufficient. These separate measurements can only be combined on an ensemble statistical basis since no particle-to-particle correlation would be available to connect size and concentration from MRPS with fluorescence measurements in flow cytometry. The best that could be obtained would be an accurate particle size distribution of particles by MRPS and a distribution of fluorescence or scatter intensities by flow cytometry, with no correlation between them.

A critical need therefore exists for a device that accurately and quantitatively measures the size, concentration and single-particle fluorescence of nanoparticles in complex, heterogenous samples.

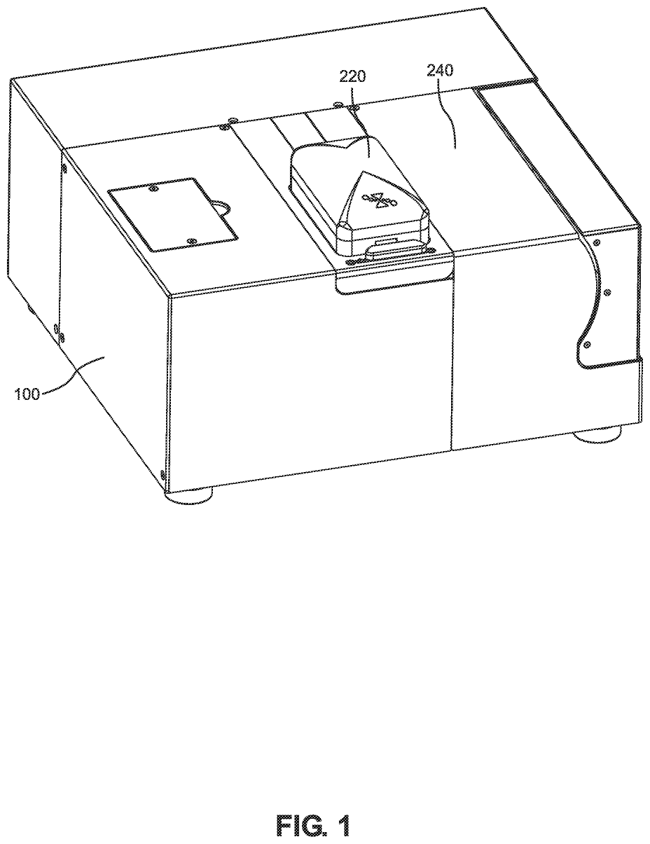

Embodiments of the invention described herein provide devices and methods for accurately and quantitatively measuring the size, concentration and single-particle fluorescence of nanoparticles in complex, heterogenous samples using microfluidic resistive pulse sensing and fluorescence. FIG. 1 shows an embodiment of the invention that includes an optics module (100), a cartridge interface (220), and a fluids module (240). In some embodiments, the devices and methods disclosed herein include an optics module, a stage for holding a microfluidic analysis cartridge, a multi-axis positioning system, a cartridge interface, and a fluids module.

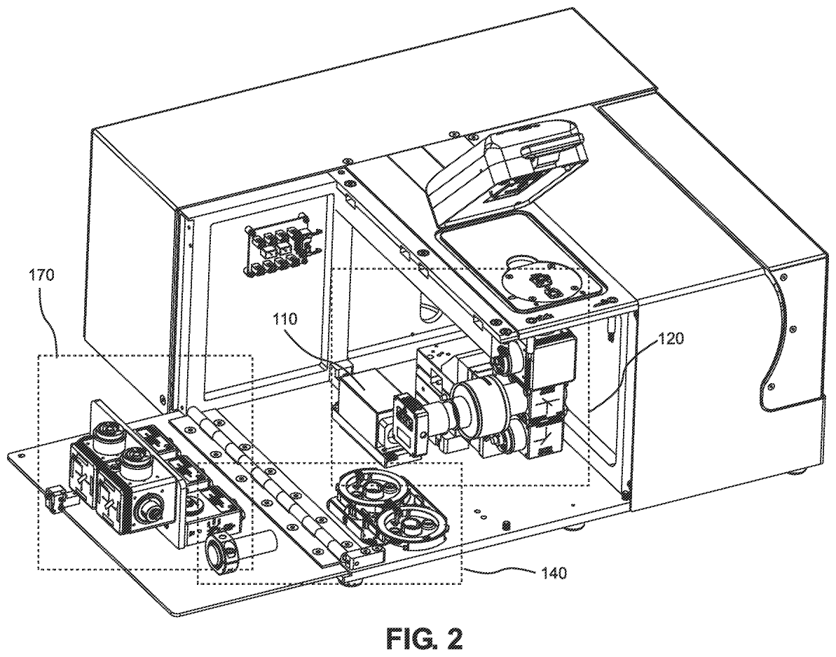

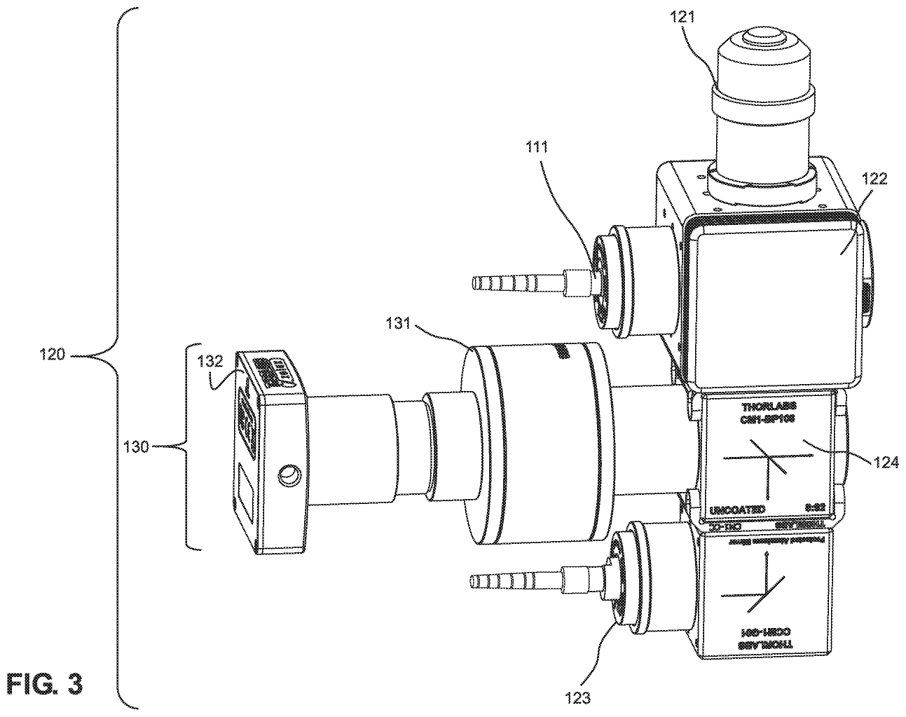

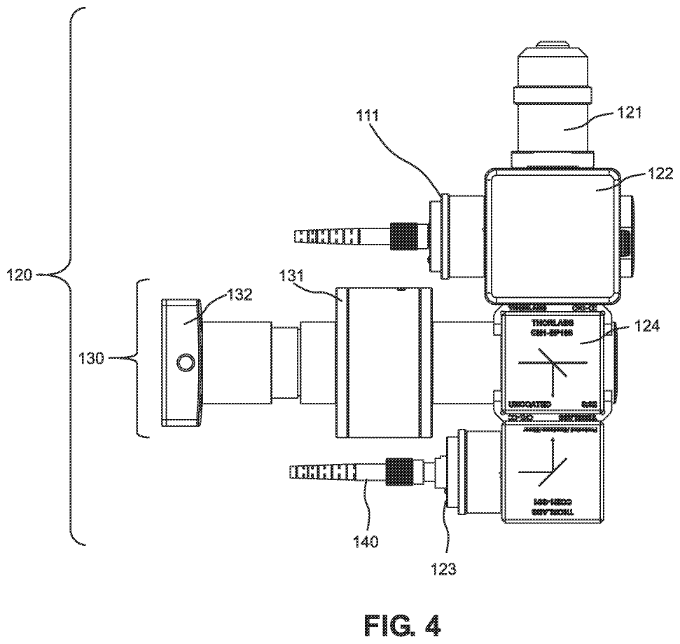

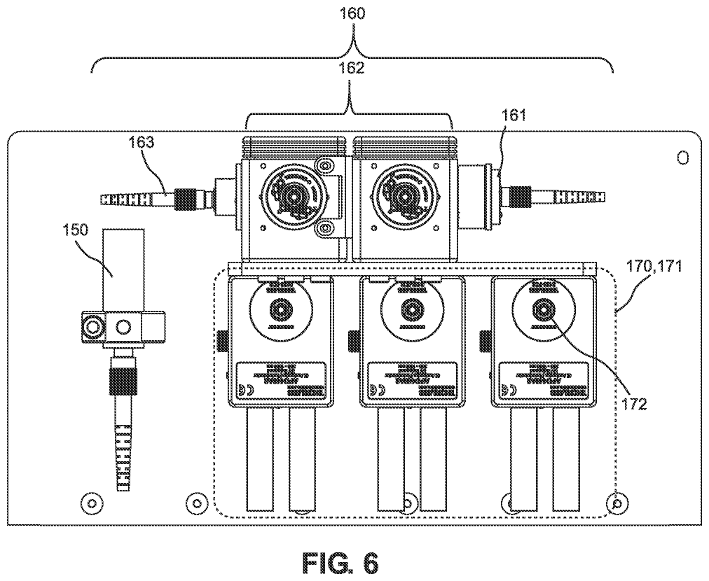

As shown in FIG. 2, in some embodiments, the optics module (100) includes an epifluorescence module (120), which includes a source of excitation light (110), a fiber splitter (140), and a detection module (170). As shown in FIGS. 3-5, in some embodiments, the optics module (100) includes an epifluorescence module (120), which includes a source of excitation light (110), components for conditioning the excitation light (111), an imaging module (130), and a fiber splitter (140). As shown in FIGS. 6-8, in some embodiments, the optics module (100) further includes a source of alignment light (150), a wavelength separation module (160), a detection module (170), and an enclosure (180).

In some embodiments, the source of excitation light (110) is a diode laser. In some embodiments, the source of excitation light (110) is a mercury lamp, or a filtered broad-band illumination source. In some embodiments, the components for conditioning the excitation light (111) include a fiber collimator (123). In other embodiments, the components for conditioning the excitation light (111) include beam shaping optics such as a vortex plate, top-hat beam shaper, or diffuser. In some embodiments, the components for conditioning the excitation light (111) include a turning mirror for directing the excitation light into the objective lens (121). In some embodiments, the components for conditioning the excitation light (111) include a pitch-yaw adjuster to adjust the position of the excitation spot.

In some embodiments, the epifluorescence module (120) includes an objective lens (121), a dichroic mirror (122), a fiber collimator (123), and a splitter mirror (124).

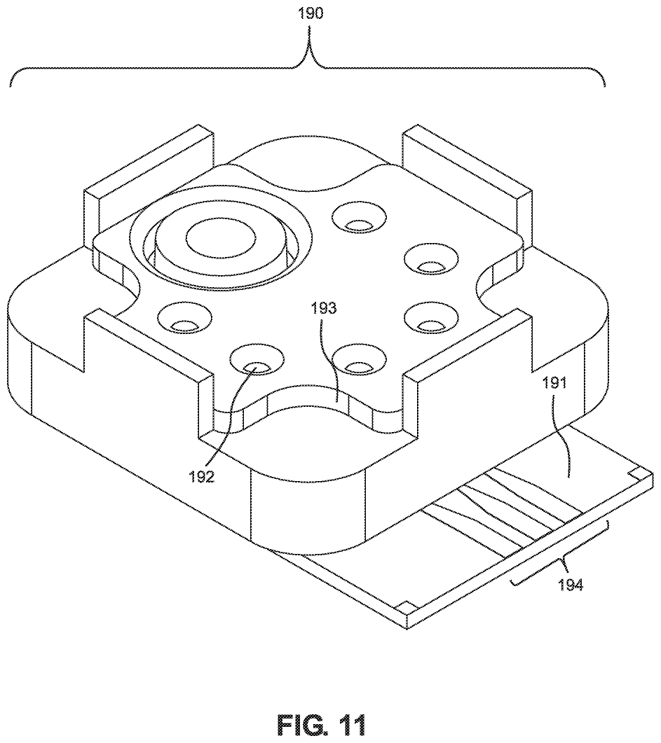

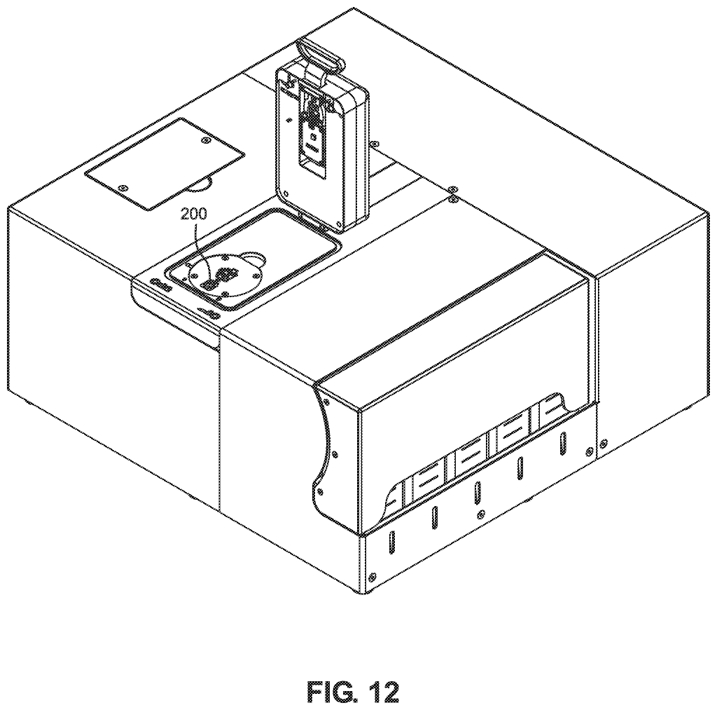

In some embodiments, the objective lens (121) focuses the light onto an excitation spot inside a microfluidic cartridge (190), shown in FIG. 11, positioned in the stage for holding a microfluidic analysis cartridge (200), shown in FIG. 12. In some embodiments, the objective lens (121) focuses the excitation light into an excitation spot that is a circular area with diameter in the range of 0.5-10 microns.

In some embodiments, the objective lens (121) collects light from the object plane of the objective lens (121). In some embodiments, the collected light includes fluorescence emission from fluorescent particles in a microfluidic cartridge (190) positioned in the stage for holding a microfluidic analysis cartridge (200).

In some embodiments, the objective lens (121) is an Olympus 40× long working distance objective suitable for fluorescence with numerical aperture 0.6 and working distance 2.7-4.0 mm. In some embodiments, the objective lens has a larger numerical aperture to collect more fluorescent light from weakly fluorescing particles in a microfluidic cartridge (190).

In some embodiments, the epifluorescence module (120) includes one or more objective lenses (121), each having different imaging capabilities. In some embodiments, the one or more objective lenses are mounted on a mechanism such as a rotating turret that allows easily exchanging objective lenses to achieve different imaging or particle detection capabilities. In some embodiments, one of the one or more objective lenses has a lower magnification and is used to locate larger-scale features in a microfluidic cartridge (190), while another of the one or more objective lenses has a higher magnification and is used to focus the excitation light and collect the fluorescence light emitted by particles in the cartridge.

In some embodiments, the dichroic mirror (122) redirects a portion of the emitted fluorescent light. In some embodiments, the dichroic mirror (122) is a short pass dichroic mirror with a wavelength cutoff that passes the wavelength of the excitation light and reflects the wavelengths of fluorescence emission.

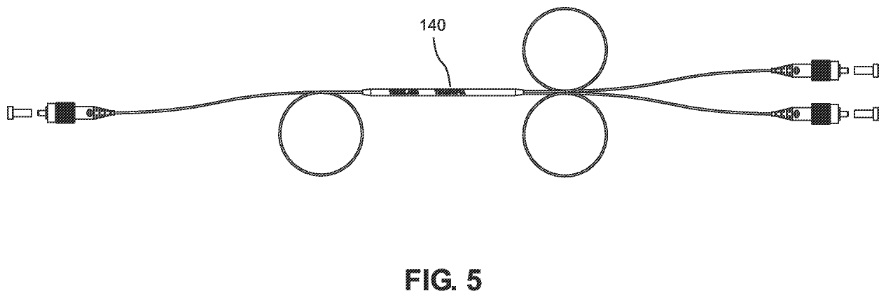

In some embodiments, the fiber collimator (123) collects and conveys the redirected portion of the emitted fluorescent light to a fiber splitter (140) shown in FIG. 5.

In some embodiments, the splitter mirror (124) redirects a portion of the remainder of the light collected by the objective (121) that passes through the dichroic (122) to an imaging module (130).

Other configurations of the epifluorescence module (120) can also be used. For example, in some embodiments, the dichroic mirror (122) is a long-pass dichroic mirror, and other components of the epifluorescence module (120) could be rearranged such that the excitation light is reflected by the dichroic mirror (122) into the objective (121) and the fluorescence emission light is transmitted by the dichroic mirror (122) to a wavelength separation module (160). Such recombinations will be apparent to those of ordinary skill in the art.

In some embodiments, the imaging module (130) includes focusing optics (131) and a digital camera (132) to form and record images of the object plane of the objective (121). Recording of such images enables automated focusing of the excitation and detection optics, automated alignment of the excitation spot with the MRPS sensing constriction in a microfluidic cartridge (190) and automated checking of the relative alignment of an excitation spot and a light-collection area of the detection optics. Recording of such images also enables imaging of the inside of a microfluidic cartridge (190) to aid in troubleshooting operation.

In some embodiments, as shown in FIGS. 2 and 5-7, the optics module (100) includes a fiber splitter (140) and a detection module (170). In some embodiments, the fiber splitter (140) joins multiple fiberoptic terminals together with known coupling coefficients between the optical pathways. In some embodiments, the coupling is a 3-way, 100:1 coupling and is inserted in the detection optical path such that alignment light can be inserted into the detection optical path in reverse to illuminate a collection area in the focal plane of the objective (121) while only minimally diminishing the intensity of emitted fluorescence light that is received by the detection module (170).

In some embodiments, the detection module (170) includes a source of alignment light (150). In some embodiments, the source of alignment light (150) is a fiber-coupled diode laser. In some embodiments, the source of alignment light (150) is a mercury lamp or a broad-band source.

In some embodiments, the source of alignment light (150) is connected to the weakly coupled port of the fiber splitter (140) and illuminates a collection area in the object plane of the objective lens (121). The collection area is the area in the object plane from which light is collected by the detection optics. In one embodiment the wavelength of the alignment light is chosen with respect to the other optical components such that its light follows an appropriate path through the optics module (100) to form an image on the digital camera (132).

In some embodiments, the source of alignment light (150) emits light having a wavelength that is longer than the wavelength cutoff of the short-pass dichroic mirror (122), so it passes through the dichroic mirror (122) and a portion is redirected by the splitter mirror (124) for imaging by the imaging module (130).

In some embodiments, the image of the collection area is used to ensure that the excitation spot lies within the collection area.

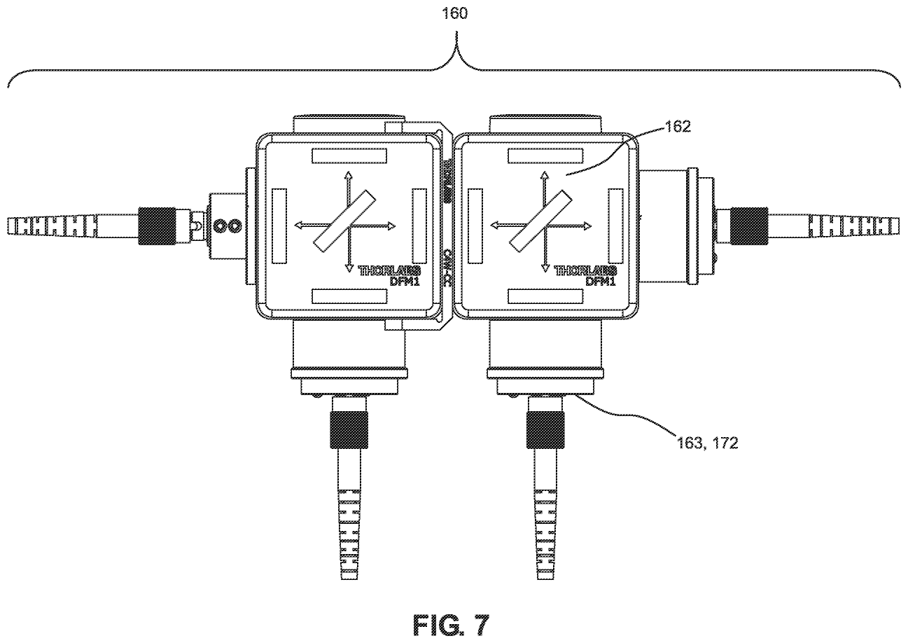

In some embodiments, as shown in FIGS. 6 and 7, the wavelength separation module (160) includes a fiber collimator (161) to collimate the emitted fluorescent light, a combination of dichroic mirrors and optical filters (162) to separate and divert certain wavelength ranges as is common in the art, and fiber collimators (163) to direct and convey each separated wavelength range into a separate fiberoptic cable.

In some embodiments, the wavelength separation module (160) is constructed and oriented within the device such that the combination of dichroic mirrors and optical filters (162) are easily exchanged to adjust the range of wavelengths to be detected by the detection module (170).

In some embodiments, the detection module (170) includes a separate light detector (171) for each wavelength range separated by the wavelength separation module (160). In some embodiments, the separate light detectors (171) are broad-band avalanche photodiode detectors with gains that are adjustable by controlling a voltage input to the detector. In some embodiments, the separate light detectors (171) are photomultiplier tubes, photon counters, or other light-sensitive detectors.

In some embodiments, the detection module (170) includes a fiber collimator (172) for each wavelength range that collimates the light to be detected and directs it onto its respective detector (171).

In some embodiments, the detection module (170) includes a multichannel measurement device for recording the output signal from each detector (171) by a computer. In some embodiments, the multichannel measurement device is an analog-to-digital converter.

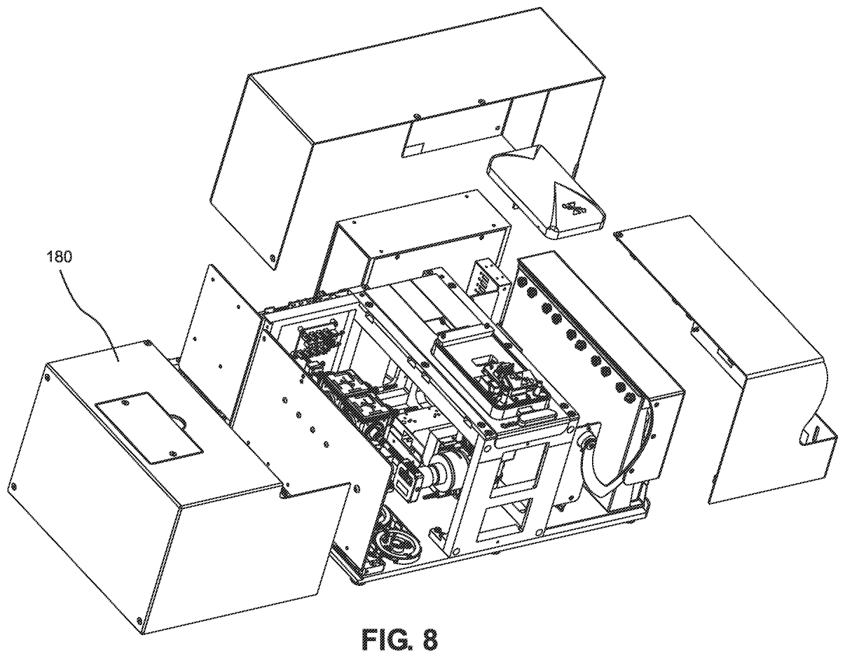

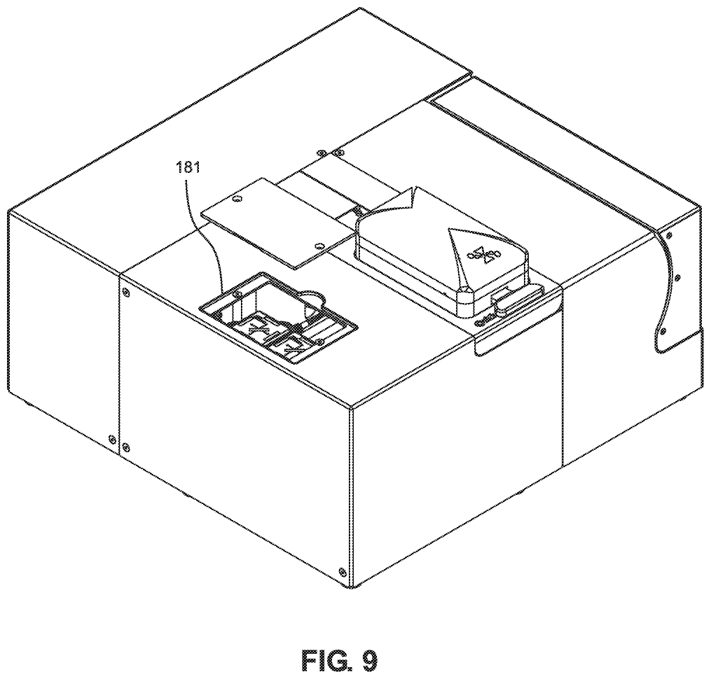

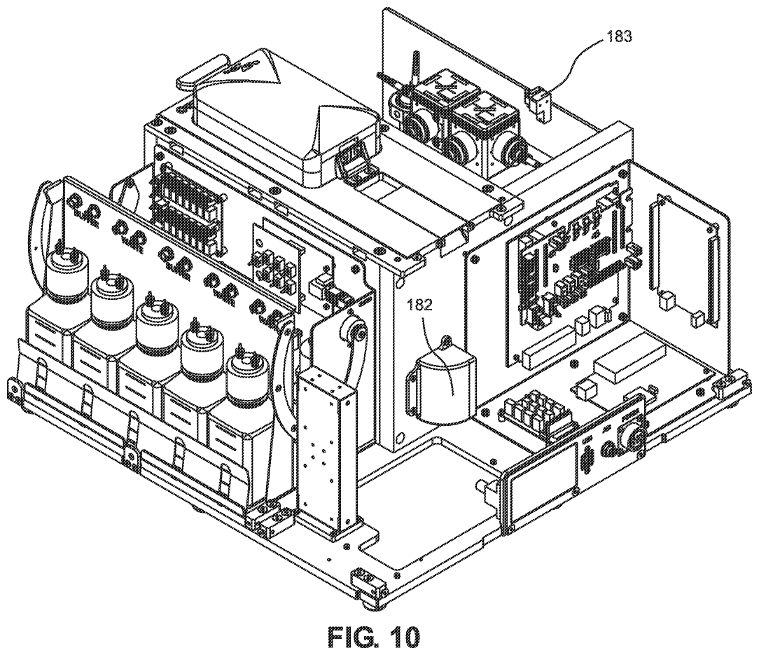

As shown in FIGS. 8-10, in some embodiments, the enclosure (180) encloses all the components of the optics module (100) and prevents any direct light path between its interior and exterior. In some embodiments, the enclosure (180) includes a removable panel (181) for accessing components of the wavelength separation module (160), a baffle (182) for passing cables into and out of the enclosure without introducing a direct light path, and sensors (183), shown in FIG. 10, for detecting when the enclosure (180) and removable panel (181) are properly fastened. In some embodiments, the sensors (183) are limit switches. In some embodiments, the sensors (183) are connected to an electrical circuit used to prevent the source of excitation light (110) and source of alignment light (150) from emitting while the enclosure (180) is open.

Generally, wavelength-dependent characteristics of components of the optics module (100) are chosen to be compatible with desired wavelengths of the configuration. For example, if a 488 nm wavelength laser is used as a source of excitation light (110), the dichroic mirror (122) should be selected with an appropriate cutoff wavelength and fiber optic cables should be used that efficiently pass the wavelengths of the relevant excitation and emission light.

In some embodiments, the focal lengths of various components of the optics module (100) are chosen such that the excitation spot is small (e.g., a circle having diameter in the range of 0.5-10 microns).

Using a small excitation spot has an advantage that particles are only illuminated for a short time as they pass through the excitation spot, thereby reducing photobleaching compared to the fluorescence-NTA method. Reduced photobleaching enables standard fluorophores and staining protocols to be used and makes the device easier to use and more easily adopted.

For a source of excitation light (110) with a given power, and for a given number of fluorochromes, using a smaller excitation spot increases the intensity of excitation light in the excitation spot, yielding higher fluorescence intensities. Using a smaller spot therefore yields a device with a lower minimum detectable fluorescence signal sensitivity.

In some embodiments, focal lengths of various components of the optics module (100) are chosen such that the excitation spot is small relative to the collection area. For example, the excitation spot could be a circle of diameter 0.5-10 microns and the collection area could be circular with approximate diameter 50-500 microns. Ensuring that the excitation spot is smaller than the collection area relaxes alignment restrictions, yielding significant advantages over the prior art.

When the excitation spot is smaller than the collection area, the instrument is easier to design, manufacture and service, and the alignment of the device is more tolerant of alignment drift since the excitation spot can move around and remain within the collection area.

The modular structure of the optics module (100), with flexible fiberoptic connections between component modules delivers significant advantages compared to conventional flow cytometry.

The modular structure allows the wavelength separation module (160) to be oriented and positioned within the device to permit easy access by a user, thus enabling a user to optimally configure the device for different applications and increased sensitivity much more easily than for a conventional flow cytometer.

The flexible fiberoptic connections between the components eliminate alignment dependencies between modules. In conventional flow cytometers, the optical paths are typically rigid, so that when the alignment of one component is adjusted, the alignment of all other optical components must be readjusted accordingly. Adjustments typically require a highly trained technician or complex alignment procedure. In the device disclosed herein, however, relative alignment of the components of the wavelength separation module (160) for example can be tuned independently from the alignment of the components of the epifluorescence module (120) and the detection module (170), making adjustment of these components much faster and easier than in conventional flow cytometry.

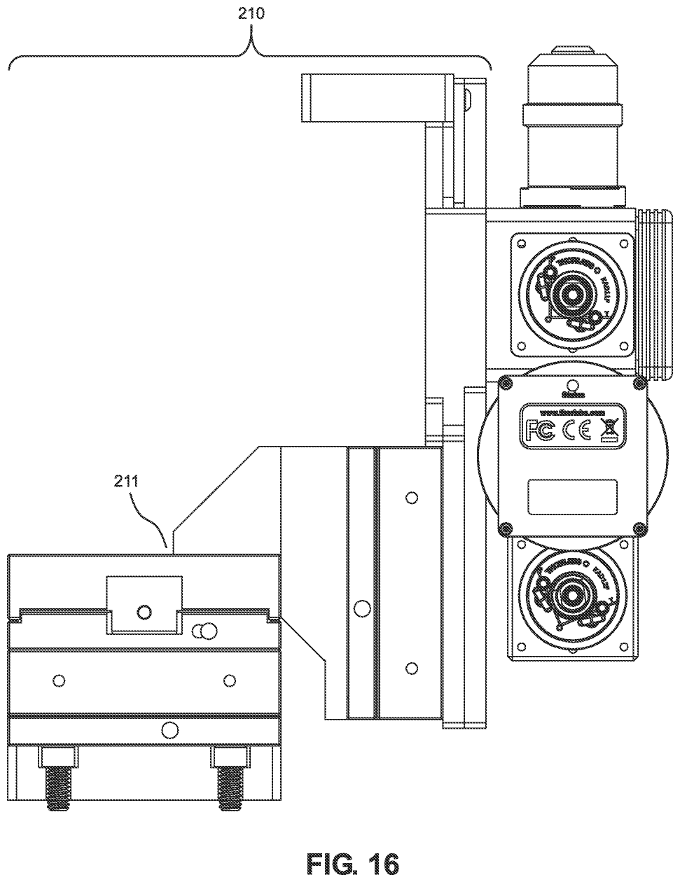

Fiberoptic connections between components also means the epifluorescence module (120) is decoupled from the other optical components, making it lightweight and more easily positionally controlled by a multi-axis positioning system (210) shown in FIG. 16.

In some embodiments, the wavelength separation module (160) and the detection module (170) are replaced by a spectrometer, allowing finer-resolution analysis of the emitted fluorescence light as a function of wavelength.

In some embodiments, the excitation light is delivered to the sample analysis region via optics from the top of the microfluidic cartridge (190). In some embodiments, the excitation light is delivered to the sample via an external optical fiber placed in proximity of the interaction region. In some embodiments, the emitted light is collected by high-numerical aperture collection optics or bare fiber in proximity to the interaction region. In some embodiments, the excitation light is shaped into an annulus or other similar shape around the MRPS interaction region providing multiple emission peaks to improve accuracy in emitted light detection.

In some embodiments, the intensity of excitation light is modulated in time to improve signal to noise of detection via lockin measurement techniques, or to enable better measurement of easily photo-bleached samples by exciting them for very short durations but multiple times, or to probe time-dependent characteristics of the fluorophores

In some embodiments, focal lengths and other properties of various components of the optics module (100) are chosen to create an excitation light spot that is large compared to the collection area.

In some embodiments, the device disclosed herein further includes a stage for holding a microfluidic analysis cartridge (200), shown in FIGS. 12-14.

In some embodiments, the stage for holding a microfluidic analysis cartridge (200) includes an optically transparent region to allow imaging of a microfluidic analysis cartridge (190), shown in FIG. 11, by the objective lens (121) of the optics module (100).

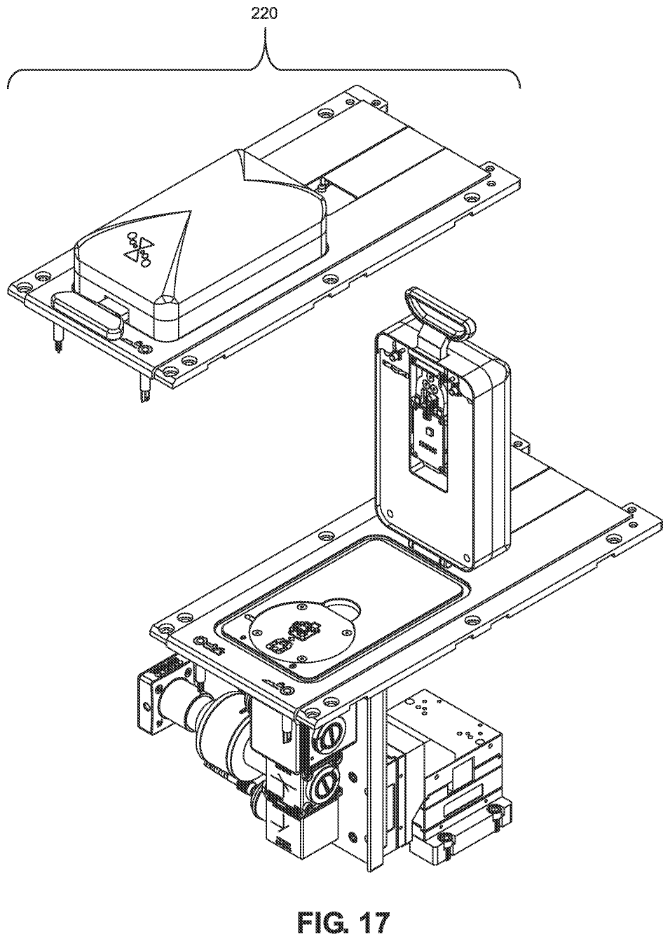

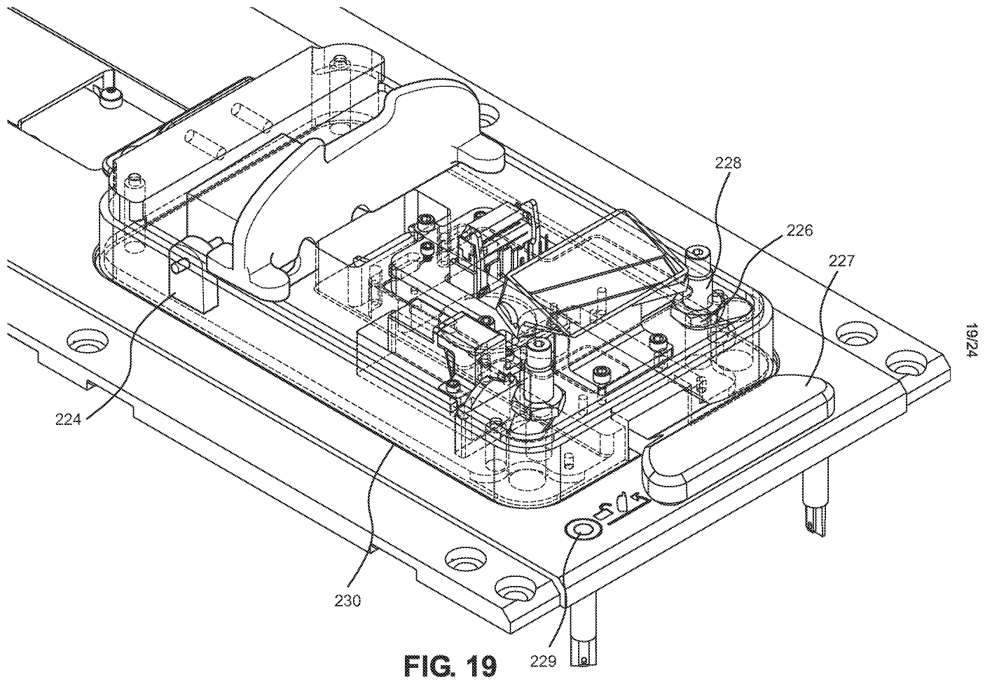

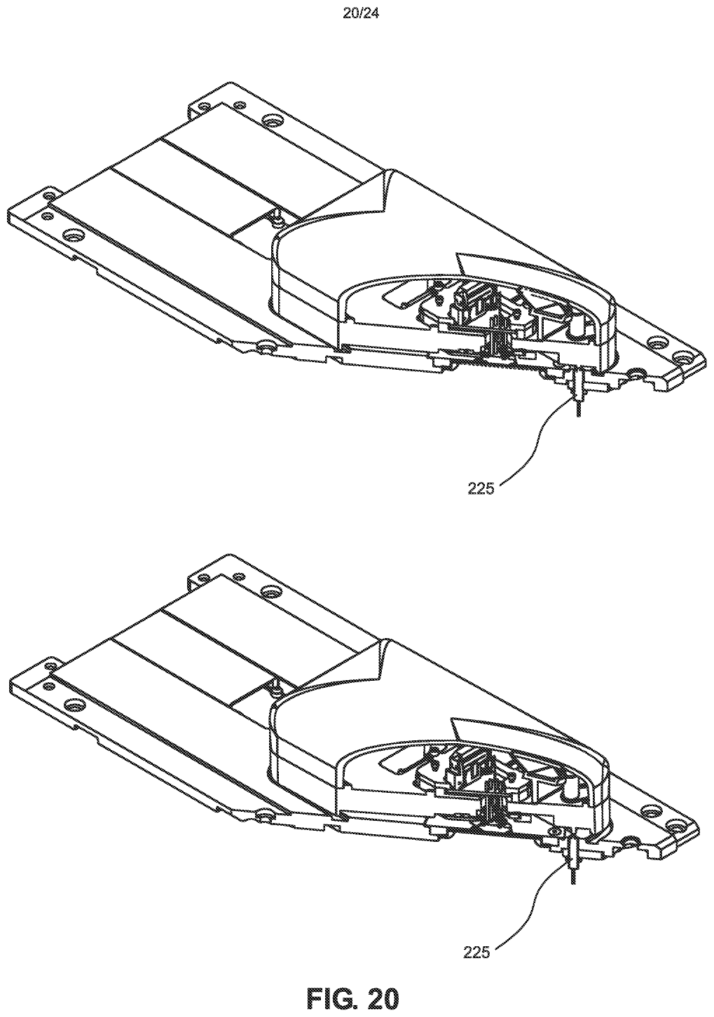

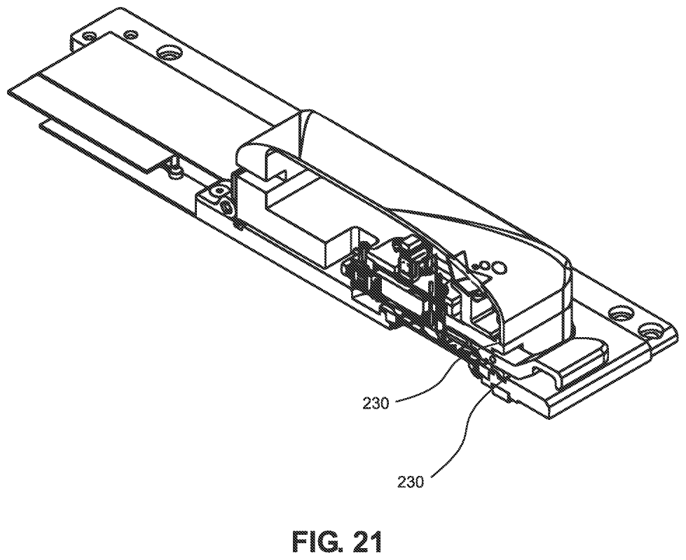

In some embodiments, the stage (200) includes a shallow recess to position a cartridge (190) in three dimensions relative to a cartridge interface (220), shown in FIGS. 17-22, and to facilitate loading of a cartridge into the stage (200) by a user.

In some embodiments, the stage (200) includes a liquid-tight seal between a loaded cartridge (190) and optics module (100) to prevent liquids from contacting and fouling optical components.

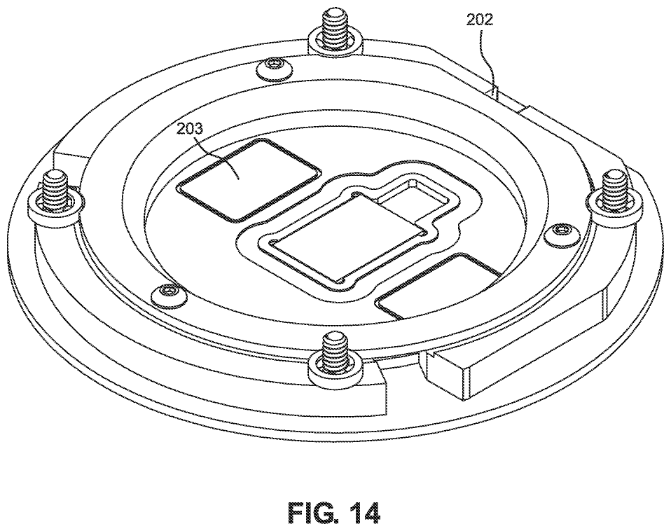

In some embodiments, the stage (200) includes reference structures, such as, for example, reference structures for positioning stage relative to the optics module (202) or reference structures for measuring the fluorescence sensitivity (203), shown in FIG. 14, having well-defined patterns and shapes that can be easily recognized by automated image analysis to allow determination of the position of the stage (200) relative to the optics module (100).

In some embodiments, the stage (200) includes reference structures (203) for measuring sensitivity of the device to fluorescent signals. For example, a surface of the stage (200) may be made to be fluorescent by painting with fluorescent paint or manufacturing from a fluorescent material, or a fluorescent material may be mounted to the stage (200) onto which the optics can be focused. In some embodiments, reference structures (203) can be used to calibrate the source of excitation light (110), calibrate the detectors (171), or check alignment between optical components such as the excitation spot and collection area.

In some embodiments, the stage (200) includes a mounted detector with which to measure the power or intensity of excitation light at regular intervals. For example, a calibrated thermal sensor that is mounted to the underside of the stage (200) onto which the excitation light can be directed to measure the power or intensity of excitation light. In some embodiments, the stage (200) includes features for mounting a removable detector.

In some embodiments, the stage (200) is sufficiently thin under a loaded cartridge (190) to allow an epifluorescence module (120) to be brought close to the loaded cartridge (190), so an objective lens (121) can be used with appropriate working distance.

In some embodiments, the stage (200) is constructed with few reflective surfaces. In some embodiments, the stage (200) is constructed of aluminum, and the aluminum may be anodized to minimize internal reflections or to make cleaning the stage easier.

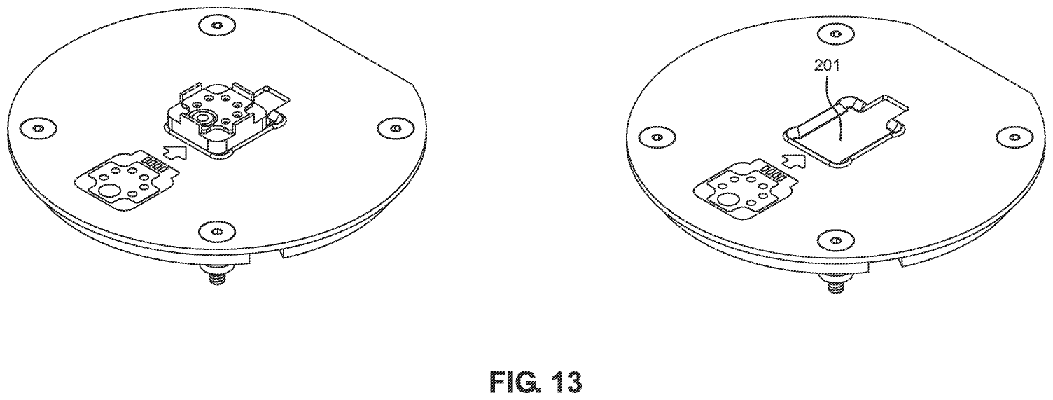

As shown in FIG. 13, in some embodiments, an optically transparent region (201) of the stage (200) is coated with a wavelength-configurable antireflective material to minimize interference of coherent light in the optics module (100). In some embodiments, the optically transparent region (201) is a glass wafer held in place by a sealed locking ring on the underside of the cartridge holder with an opening in the cartridge holder to permit light to pass. In some embodiments, the optically transparent region (201) is coated with a material that minimizes reflections at interfaces of different materials by reducing the difference in refractive indices between materials of the interface. For example, a thin layer of oil may be used between the transparent region (201) and the microfluidic analysis cartridge (190) to better match the index of refraction of the transparent region (201) and the cartridge (190).

In some embodiments, the stage (200) is mostly flat and smooth to make cleaning the stage (200) easier.

As shown in FIG. 16, in some embodiments, the multiaxis positioning system (210) is a computer-controlled positioning stage (211) to which components of the optics module (100) are mounted. In some embodiments, the multiaxis positioning system (210) includes reference surfaces with which to align optical components when mounted and ensure fine accuracy in their positioning.

In some embodiments, the multiaxis positioning system (210) is a 3-axis stepper motor-driven positioning stage to which the epifluorescence module (120) and imaging module (130) are mounted. Such an embodiment enables an excitation spot to be focused and aligned with very high accuracy to the MRPS sensing constriction inside a microfluidic cartridge (190). Positioning the excitation spot on or close to the MRPS sensing constriction delivers simultaneous or near-simultaneous detection of fluorescence and MRPS signals, meaning fluorescence measurements can be easily correlated with MRPS measurements of size & concentration.

Computer controlled routines that use images from the camera (132) as input can be used to automatically align the excitation spot to the MRPS sensing constriction in 3 dimensions, without requiring the use of any fluorescent sample to optimize alignment. In contrast, flow cytometers have relatively rigid optical paths and require complex protocols to align the optics for optimal fluorescence measurements that include performing complete measurements of fluorescent particles. Such protocols require significant time and must be performed by highly trained personnel.

In some embodiments, images from the camera (132) can be used to align the excitation spot in three dimensions to accommodate variations in the placement position of different cartridges (190) in the cartridge holding stage (200), which in turn makes it practical and feasible to use exchangeable and disposable microfluidic cartridges (190) for analysis and eliminate concerns about contamination between samples and cleaning requirements. In conventional flow cytometry, the flow cell must remain in careful alignment to the excitation spot, meaning it cannot be easily replaced for each measurement, meaning a single flow cell must be reused and cleaned in between runs costing time and cleaning reagents.

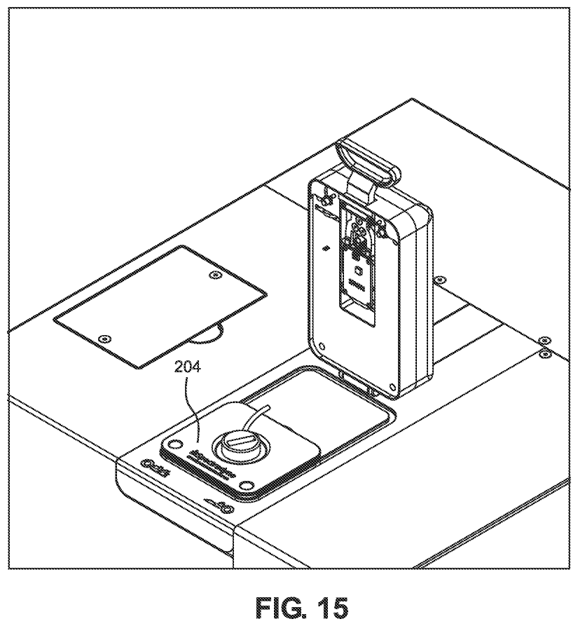

In some embodiments, the excitation light can easily be directed onto a mounted detector (204), shown in FIG. 15, to quantify the power and intensity of the excitation light at regular intervals, thereby making results more consistent between measurements, improving repeatability of instrument operation, and allowing the detection of changing or failing source of excitation light (110). These advantages in turn allow use of lower cost sources of excitation light (110) that might have variable output powers. In contrast, flow cytometers have rigid optical paths, making it practically difficult to redirecting the excitation light to a sensor.

In some embodiments, the excitation light and collection area can easily be directed onto a fluorescent reference material (203) to measure the sensitivity of the fluorescence detection system, making it easier to align or detect misalignments in the optical components used for fluorescence detection.

In some embodiments, the objective lens (121) is focused on one or more fluorescent films (203) with known fluorescence attached to the underside of the stage for holding a microfluidic cartridge (200), and the signals detected in the APDs used to optimize the alignment of the components in the wavelength separation module.

As shown in FIGS. 17-22, in some embodiments, a cartridge interface (220) is provided that includes electrical interfacing components (221) that make electrical connections to a cartridge (190) in the stage (200) and fluid interfacing components (222) that make fluidic connections to a cartridge (190) in the cartridge holder (200).

In some embodiments, the cartridge interface (220) is connected by a hinge (223) to the stage (200) to reversibly engage and disengage the electrical interfacing components (221) and fluidic interfacing components (222) into connection with a cartridge (190) in the stage (200).

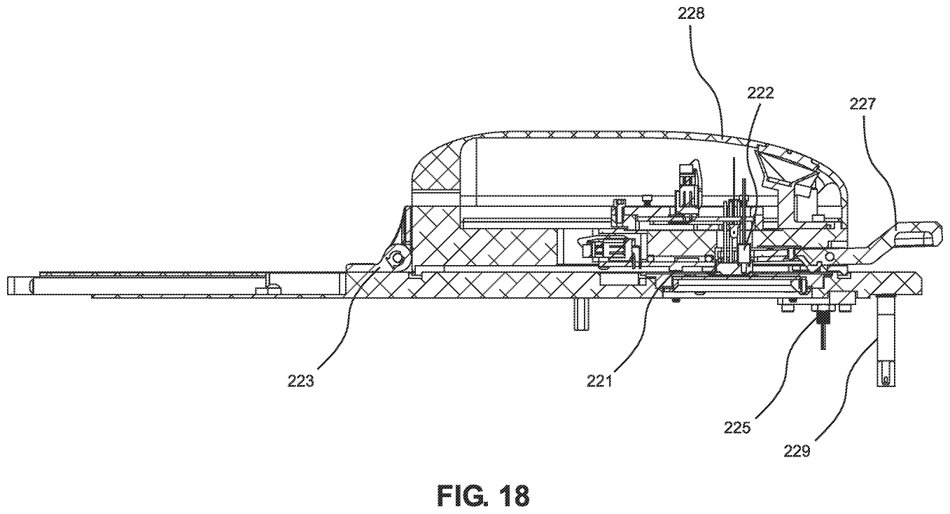

As shown in FIGS. 18-22, in some embodiments, the cartridge interface (220) includes a locking mechanism (224) for safety and to eliminate chance of accidentally disengaging fluid interfacing components (222) during operation that might cause a leak. In some embodiments, the cartridge interface (220) includes sensors (225) to detect if the interface is mechanically engaged and properly closed to prevent leaks. For example, the sensors (225) can be limit switches. In some embodiments, the cartridge interface (220) includes magnetic catches (226) to fully close and maintain full engagement of the cartridge interface (220) with a cartridge (190).

In some embodiments, the cartridge interface (220) includes a lever arm (227) for securing a cartridge (190) while disconnecting the fluid interfacing components (222) and electrical interfacing components (221). In some embodiments, the cartridge interface (220) includes shock absorbers (228) that reduce impact force when interfacing components are brought into contact with a cartridge (190). In some embodiments, the cartridge interface (220) includes indicator lights (229) to show a user the status of the interface. In some embodiments, the indicator lights (229), are hard-wired to sensors (225).

In some embodiments, the cartridge interface (220) includes a tongue and groove mating (230) with the cartridge holder (200) to ensure no direct light path exists between the interior of the cartridge interface (220) and the exterior when the interface is engaged. Such an embodiment prevents leakage of external light into the optics module (100) and prevents direct leakage of internal light out of the instrument, thereby reducing safety hazards and reducing any regulatory burden that would otherwise be incurred by allowing high intensity excitation light to exit from the instrument.

In some embodiments, the cartridge interface (220) includes an opaque cover to block any light leakage into or out of the closed cartridge interface through the back of the cartridge interface.

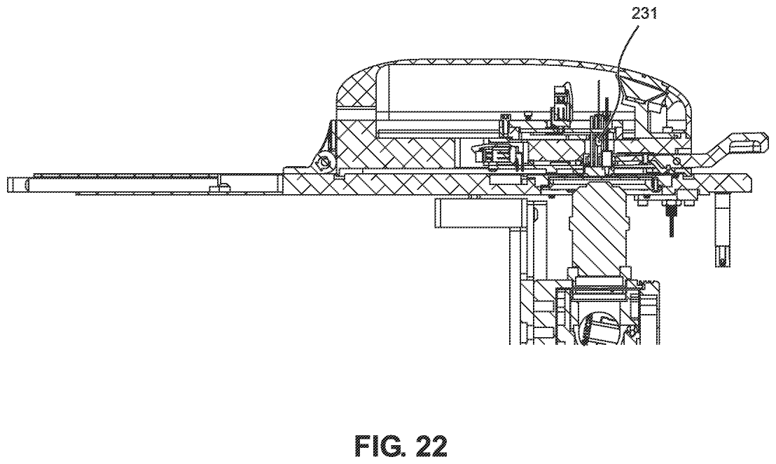

In some embodiments, the cartridge interface (220) includes a source of broad-field imaging light (231) as shown in FIG. 22. In some embodiments, the source of broad-field imaging light (231) has variable intensity that is electrically controlled. In some embodiments, the source of broad-field imaging light (231) is aligned such that the broad-field imaging light illuminates a microfluidic analysis cartridge (190) in such a way as to permit broad-field imaging of the features in the cartridge (190) by a camera (132) in the optics module (100).

In some embodiments, the source of broad-field imaging light (231) emits light with wavelength in accordance with the configuration of the optics module (100) such that a fraction of the light is directed to the camera. In some embodiments, the source of broad-field imaging light (231) is a blue LED mounted in the cartridge interface (220) that directs light through a microfluidic analysis cartridge (190) and into an objective (121).

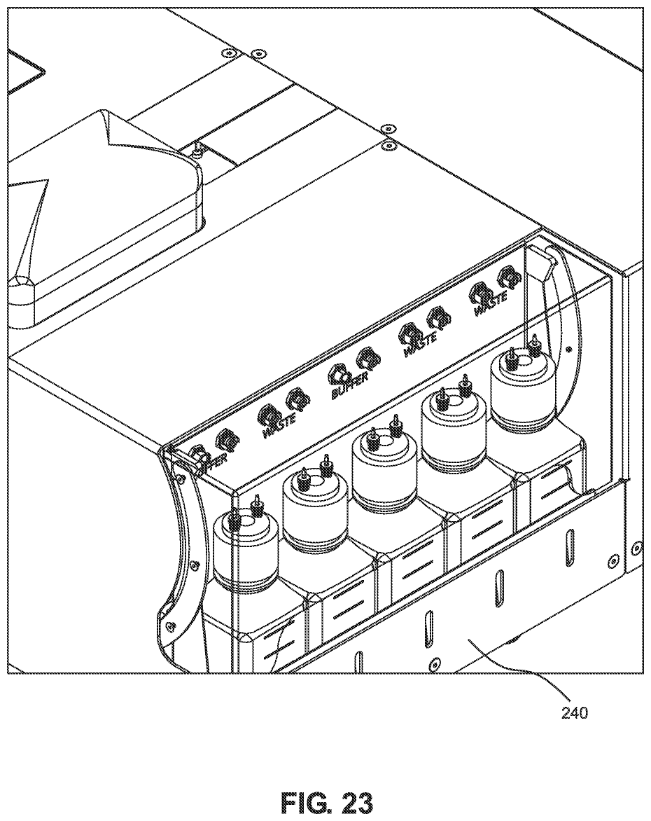

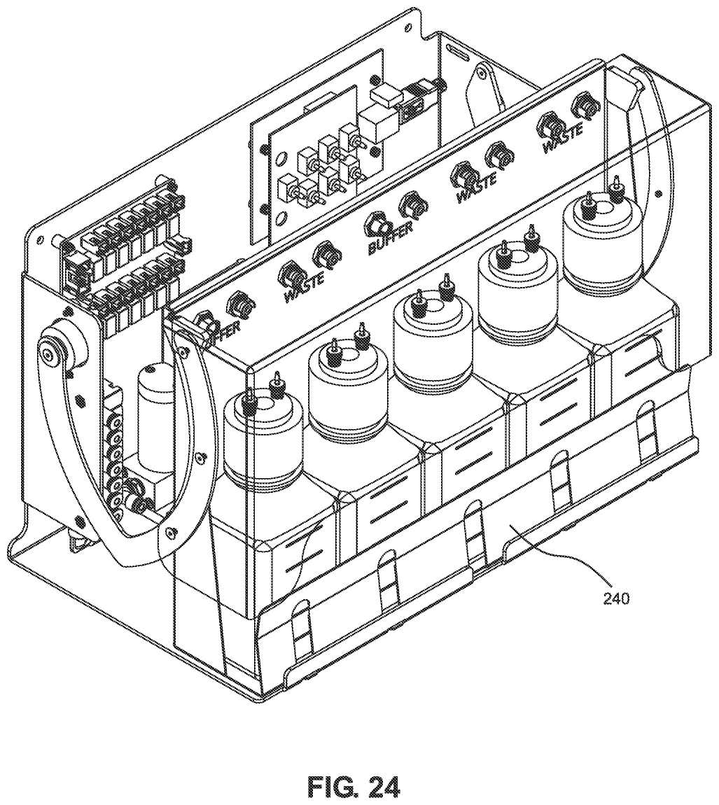

As shown in FIGS. 23 and 24, in some embodiments, the device includes a fluids module (240), which includes components for controlling pressures and directing fluids in a microfluidic analysis cartridge (190). In some embodiments, the fluids module (240) is isolated from the optics module (100) and some electrical components to prevent accidental fluid spills from damaging the optics or electrical components. In some embodiments, the fluids module (240) is connected to the cartridge only by a single set of seamless fluid lines to minimize the risk of leaks.

As shown in FIG. 11, in some embodiments, an optional microfluidic analysis cartridge (190) in which to perform particle analysis by microfluidic resistive pulse sensing is inserted into the stage for holding a microfluidic cartridge (200).

In some embodiments, the microfluidic analysis cartridge (190) includes a transparent material (191) that provides optical access to the MRPS sensing constriction and other regions of the fluidic channels. In some embodiments, the microfluidic analysis cartridge (190) includes a sample reservoir (192) that is optically accessible. In some embodiments, the sample reservoir (192) is used to make bulk fluorescence measurements of a sample in the sample reservoir (192).

In some embodiments, the microfluidic analysis cartridge (190) includes optical alignment features or reference markings (193) to enable alignment of optics to the MRPS sensing constriction or other points of interest in the cartridge. In some embodiments, the locations of the reference markings (193) are well defined relative to one another and to the MRPS sensing constriction to allow determination of imaging location in the microfluidic cartridge.

In some embodiments, the microfluidic analysis cartridge (190) includes fluidic channels with patterns that are easily recognized by automated image analysis techniques.

In some embodiments, the reference markings (193) are built into the walls of the fluidic channels and have shapes that are easily recognized by automated image analysis algorithms. In some embodiments, the reference markings (193) are in the shape of a pair of intersecting lines. In some embodiments, the reference markings (193) are isolated from any fluid channels in the cartridge (190) so that their optical properties are unchanged whether the cartridge has been filled with liquid or not, making recognition by automated image analysis independent of whether the cartridge has been filled by a liquid.

In some embodiments, the microfluidic analysis cartridge (190) includes conductive electrical contacts (194) with which to make electrical sensing measurements. In some embodiments, the conductive electrical contacts (194) can be used for focusing and aligning optics. In some embodiments, the conductive electrical contacts (194) have sharp edges to enable autofocus algorithms to be more precise and accurate. In some embodiments, the conductive electrical contacts (194) are more easily used to accurately focus optics than other features in the microfluidic cartridge, even if focus on other features is the most important.

In some embodiments, the conductive electrical contacts (194) are in approximately the same optical plane as the MRPS sensing constriction, so that when optics are focused on the electrical contacts (194) the MRPS sensing constriction is also in focus. In some embodiments, the conductive electrical contacts (194) have well-defined patterns and shapes that can be easily recognized by automated image analysis to allow determination of imaging location in the microfluidic cartridge.

In some embodiments, one or more surfaces of the microfluidic cartridge (190) include an anti-reflective coating to reduce reflections.

In some embodiments, the microfluidic analysis cartridge (190) has conductive electrical contacts (194) made of chromium and gold patterned on glass, and the conductive electrical contacts have compound shapes including a rectangular portion and multiple leads having well-defined geometries and small enough to fit in the field of view of the objective lens (121) that can be used for focusing and aligning the epifluorescence module (120) and imaging module (130), a sample reservoir (192) for performing reference markings alignment features (193) in the shape of intersecting lines molded into a polymer portion of the microfluidic analysis cartridge (190) that are in known relative alignment to a sensing constriction in the cartridge that are isolated from any fluid in the cartridge (190) and can be imaged by the imaging module (130) and used to automatically align an excitation spot with the sensing constriction.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A device for combined fluorescence and microfluidic resistive pulse sensing, comprising:
an optics module comprising one or more optical components mounted to a multi-axis positioning system;
a stage for holding a microfluidic analysis cartridge;
a cartridge interface; and
a fluids module.

2. The device of claim 1, wherein the multi-axis positioning system is capable of positioning the one or more optical components relative to the stage.

3. The device of claim 1, wherein the stage provides a means for positioning a cartridge relative to the cartridge interface.

4. The device of claim 1, wherein the fluids module is fluidically connected to the cartridge interface.

5. The device of claim 1, wherein the fluids module comprises components for controlling pressures and directing fluids in a microfluidic analysis cartridge.

6. The device of claim 1 wherein the optics module comprises a source of excitation light, an epifluorescence module, and a detection module.

7. The device of claim 6, further comprising one or more components for conditioning the excitation light.

8. The device of claim 6, wherein the optics module further comprises an imaging module.

9. The device of claim 6, wherein the optics module further comprises a fiber splitter.

10. The device of claim 6, wherein the optics module further comprises a source of alignment light.

11. The device of claim 6, wherein the optics module further comprises a wavelength separation module.

12. The device of claim 1, wherein the stage for holding a microfluidic cartridge comprises an optically transparent region.

13. The device of claim 1, wherein the cartridge interface comprises one or more electrical interfacing components.

14. The device of claim 1, wherein the cartridge interface comprises one or more fluid interfacing components.

15. A microfluidic cartridge comprising one or more electrical contacts for sensing and one or more reference markings for focusing and aligning the one or more optical components in the optics module of the device of claim 1.
